(19) United States
(12) Patent Application Publication
(10) Pub. No.: US 2014/0072843 A1
(43) Pub. Date: Mar. 13, 2014

(54) ELECTROCHEMICAL ENERGY STORE

(71) Applicants: Dirk LIEMERSDORF, Sachsenheim (DE); Frank BAUMANN, Mundelsheim (DE); Bernd SCHUMANN, Rutesheim (DE); Jens GRIMMINGER, Leonberg (DE); Thomas CLASSEN, Stuttgart (DE); Kathy SAHNER, Leonberg (DE); Joerg THIELEN, Stuttgart (DE)

(72) Inventors: Dirk LIEMERSDORF, Sachsenheim (DE); Frank BAUMANN, Mundelsheim (DE); Bernd SCHUMANN, Rutesheim (DE); Jens GRIMMINGER, Leonberg (DE); Thomas CLASSEN, Stuttgart (DE); Kathy SAHNER, Leonberg (DE); Joerg THIELEN, Stuttgart (DE)

(73) Assignee: ROBERT BOSCH GMBH, Stuttgart (DE)

(21) Appl. No.: 14/016,835

(22) Filed: Sep. 3, 2013

(30) Foreign Application Priority Data
Sep. 7, 2012 (DE) 10 2012 215 884.7

(51) Int. Cl. H01M 10/42

(52) U.S. Cl. CPC H01M 10/4228
USPC 429/61; 429/90

(57) ABSTRACT

An electrochemical energy store, e.g., a lithium-ion battery, includes a cell chamber, in which at least one anode, at least one cathode, and an electrolyte, which is situated between the anode and the cathode, are situated, the cell chamber being separated from the external surroundings by a housing, and at least one detection substance for the detection of a leak of the housing being situated in the cell chamber. The energy store configuration allows a leak of the energy store to be detected in a simple way.

### BACKGROUND OF THE INVENTION

1. Field of the Invention

The present invention relates to an electrochemical energy store, e.g., a lithium-ion battery, and to an energy store system including such an energy store.

2. Description of the Related Art

It is known of lithium-ion batteries, for example, for lithium sulfur batteries, as energy stores, that they have a very high energy density. This is advantageous in particular for applications having a high power demand. Exemplary applications include, for example, laptops, mobile telephones, smart phones, or other applications. In the case of the electrification of automobiles, which is presently being strongly promoted, such batteries also play a large role. Furthermore, applications are also conceivable, for example, as energy stores for current from solar cells or wind power plants.

Due to the high energy contents, for example,, it is advantageous if damage to or malfunctions of such energy stores may be recognized early.

### BRIEF SUMMARY OF THE INVENTION

An object of the present invention is an electrochemical energy store, in particular a lithium-ion battery, including a cell chamber, in which at least one anode, at least one cathode, and an electrolyte, which is situated between anode and cathode, are situated, the cell chamber being separated from the external surroundings by a housing, and at least one detection substance for detecting a leak of the housing is situated in the cell chamber.

A lithium-ion battery may be understood within the scope of the present invention to be in particular a battery which is at least partially based on lithium, and which uses lithium or lithium ions during the electrochemical process of its charging or discharging cycle. A lithium sulfur battery may be mentioned as an example of a lithium-ion battery. Furthermore, the term battery may be understood to include in particular a primary cell and also a secondary cell, i.e., in particular a rechargeable accumulator.

Furthermore, a cell chamber may be understood within the meaning of the present invention to be in particular an area, which is advantageously at least partially or in particular completely closed with respect to the external surroundings, of a galvanic cell in particular. In other words, in particular the actual electrochemical reaction of the energy store may run in the cell chamber.

Furthermore, a detection substance within the meaning of the present invention may be in particular a substance or a material which is directly used for the purpose of detecting a leak, such as in particular an undesired opening or possible exit of material situated in the cell chamber. The detection substance may in particular be such a substance, which is chemically inert in the case of the electrochemical reaction running during operation of the energy store, i.e., does not itself participate in the reaction or the operation of an energy store. Alternatively, the detection substance may assume a double function and, for example, in addition to the function as a detection substance, also have a positive influence on the formation process of a functional and stable SEI (solid electrolyte interphase).

Therefore, a detection substance may essentially be a substance which does not assume a further function during an operation of the energy store in addition to the detection of a leak, but rather is only incorporated as a monitoring agent in the interior of the cell chamber and which may immediately and directly indicate a leak, in particular on the basis of its properties, or may assume a double function.

An above-described energy store permits a leak or an undesired opening of a housing which delimits the energy store to be able to be detected immediately, so that damage to the energy store or components situated in the surroundings of the energy store may be reduced or prevented.

### DETAILED DESCRIPTION OF THE INVENTION

Such an energy store, in particular a lithium-ion battery, includes a cell chamber, in which at least one anode, at least one cathode, and an electrolyte, which is situated between the anode and the cathode, are situated. The electrolyte, the anode, and the cathode may be designed in a way known per se, which is customary for an electrochemical energy store.

For example, the cathode or the anode may have a current collector, on which a suitable active material is situated. For the solely exemplary and non-restrictive case of a lithium sulfur battery, for example, in the case of the cathode, an aluminum foil may be provided as the current collector, on which elementary sulfur is provided as an active material, in particular in a binder. In the case of the anode, a copper foil may be provided as the current collector. The binder may include or be composed of a polymer, for example, polyvinylpyrrolidone, polybutadiene, cellulose, or cellulose derivatives, for example, having one or multiple methyl, ethyl, propyl, or hydroxyl groups and/or carboxymethyl groups, for example, carboxymethylcellulose. Furthermore, a conductive additive, for example, carbon black or graphite, may be provided in the binder, to be able to provide a sufficient electrical conductivity.

A metallic lithium electrode may be used as an anode, for example, also for the solely exemplary case of a lithium sulfur battery.

The electrolyte situated between the cathode and the anode may also include, for example, as an electrolyte solvent, organic carbonates, cyclic ethers, acyclic ethers, or combinations thereof, and/or, as a conductive salt, lithium-bis-(trifluoromethane sulfone) imide (LiTFSI), another lithium salt such as lithium phosphorus hexafluoride (LiPF₆), or another conductive salt such as lithium-bis-(oxalato) borate (LIBOB) or a partially fluorinated component thereof.

Furthermore, a separator, for example, an ion-conductive polymer, film, for example, a polyolefin, polypropylene, or polyimide, or a polyterephthalate, may be provided in a way known per se between the anode and the cathode. Furthermore, a ceramic coating, which increases the safety, may be provided on the separators or the electrodes.

In the case of an above-described energy store, the cell chamber is at least partially, in particular completely, separated by a housing from the external surroundings, i.e., the atmosphere enclosing the energy store. It is apparent to those skilled in the art that in particular areas of the anode or the cathode may protrude from the cell chamber for tapping electrochemical energy; however, the cell chamber may be closed in particular to prevent an escape of fluids situated in the cell chamber.

Furthermore, at least one detection substance for detecting a leak of the housing is situated in the cell chamber. It may thus be made possible that, for example, the leak may be directly or indirectly detectable on the basis of the detection substance or a property of the detection substance due to an escape of the detection substance through the leak or due to a change of the detection substance by the leak of the housing.

Therefore, an above-described energy store may be designed to be able to detect the detection substance, for example, after an escape from the energy store or from a housing which delimits the energy store into the atmosphere enclosing the energy store. In this case, due to the mere presence of the detection substance outside the energy store, in particular a leak may be inferred immediately and directly. An increase with respect to time of the quantity of the detection substance may permit an indication of the size of the leak. Alternatively or additionally, a change of the detection substance or a property of the detection substance due to the leak within the energy store may be possible, without departing from the scope of the present invention.

Due to the provision of the detection substance, therefore, even small or ultra-small leaks may be reliably detectable, so that the consequences occurring as a result of the leak and the potential escape of a substance situated in the interior of the cell chamber may be reduced or entirely prevented. In detail, for example, the signaling of a leak may already be detectable by a small escape of the detection substance, for example, through ultra-small cracks, whereby the actual escape of the electrolyte, for example, may be prevented by appropriate measures. Therefore, on the one hand, a malfunction of the energy store may be prevented, and furthermore damage to components situated in the neighborhood of the energy store, for example, further energy stores or other components, may be prevented.

An above-described energy store may therefore operate particularly safely and reliably, whereby greater damage may be reduced or prevented completely. Furthermore, malfunctions at the actual energy store may be reduced or in particular prevented completely. Furthermore, the energy store may be shut down in the event of detection of a leak, so that damage to the energy store, components connected thereto, and/or adjacent components may be effectively prevented.

The above-described increase in safety may be implementable particularly simply and cost-effectively, since the provision of a detection substance is possible in a simple way and without retrofitting. Furthermore, the detection substance per se may also be available cost-effectively.

Within the scope of one embodiment, the detection substance may include or be composed of a gas or a low-boiling liquid. In particular by way of the provision of a gas or a low-boiling liquid as the detection substance, the latter may already reach the atmosphere surrounding the energy store from the interior of the cell chamber through ultra-small openings or leaks and therefore may already indicate a crack, a leak, or a similar opening when no further material or fluid situated in the cell chamber, for example, electrolyte material, may still escape therethrough. An escape of material from the energy store may thus be prevented in a particularly advantageous way, whereby a malfunction of the energy store or damage to adjacent components may be prevented particularly effectively. A low-boiling liquid may have the same advantages as a gas, since it may not be present as a liquid, but rather as a gas, in particular already due to the operating temperature of the energy store. Within the meaning of the present invention, a low-boiling liquid may also be understood to be a liquid which has a boiling point which is in a range of less than or equal to 35° C. at normal pressure, for example.

Within the scope of another embodiment, the detection substance may include a material which is selected from the group composed of nitrogenous substances, sulfurous substances, phosphoric substances, hydrogenous substances, carbonaceous substances, substances containing oxygen, hydrocarbon compounds, acids, in particular organic acids or salts thereof, heterocyclic compounds, in particular having sulfur, phosphorus, or nitrogen, or mixtures of the above-mentioned substances.

Such substances may, as explained hereafter, have particularly positive properties with respect to their detection behavior, whereby a leak may be detectable particularly reliably and simply.

Within the scope of another embodiment, the detection substance may be detectable by its odor. In this embodiment, the provision of mechanical or electronic sensors, for example, may be essentially omitted, which may make an energy store of this design particularly cost-effective. Detection of the detection substance, which has escaped through a leak from the interior of the cell chamber, for example, may be implementable solely by the user of an energy store designed as described above. The user may be made aware of a leak solely by the detection substance and therefore by a noticeable odor. This may oftentimes enable a particularly reliable detection of a leak. Detection by the odor may be made possible in particular in that the odor intensity of the detection agent may exceed its odor threshold already in the parts per million range, solely as an example in a range of less than or equal to 5 ppm, for example, greater than 10 ppm, and may be perceptible, and therefore may immediately emit a warning or may make detection possible already upon the occurrence of a leak. Thus, for example, the leak may also possibly still be repaired in this early stage. Fundamentally, substances may be perceptible by their odor in particular if they are present above their odor threshold, i.e., if their odor unit is equal to or greater than 1 OU/cm³, which may be ascertained in particular in the application of DIN EN 13725:2003.

For a detection substance, in this embodiment in particular gaseous or low-boiling substances may be suitable, since they may diffuse in a particularly simple way from the energy store to the user, to thus be able to ensure detection of a leak. Such an odor-producing substance may already be present in the energy store, for example, or a precursor of the odor-producing substance may be present in the energy store or in its housing, so that the odor-producing substance is only formed after escaping from the energy store, for example, by an oxidative reaction in the atmosphere enclosing the energy store.

Within the scope of another embodiment, the detection substance may include a material which is selected from the group composed of aromatic substances, esters, ethers, terpenes, alkyl pyrazines, ketones, aldehydes, lactones, acrylates, amines, nitriles, alcohols, mercaptans or thiols, thioethers, phosphides, phosphones, derivatives of the above-mentioned substances, or mixtures of the above-mentioned substances. The detection substance may be formed from one or multiple of the above-mentioned organic substances, or in particular synthetic or natural flavorings, or may be composed thereof. The above-mentioned substances may be suitable, in particular, as strong odor producers, for already being detectable in a small quantity or concentration. It may thus be made possible in a particularly advantageous way in this embodiment that ultra-small quantities of escaped detection substance may already be reliably detected by a user on the basis of the odor, whereby ultra-small leaks are already reliably detectable and an energy store of this design may operate particularly reliably and safely or may indicate damage.

Furthermore, it may be considered to be an advantage of the above-mentioned groups that the substances dissolved in the electrolyte, for example, do not negatively influence the SEI formation (solid electrolyte interphase) and the performance of the cell, and are accordingly as inert as possible within the scope of the cell chemistry, or, in addition to their function as an aroma sensor, as a positive secondary effect, assist the formation of a stable and functional SEI during the formation, without being completely consumed.

As concrete examples of comparatively inert odorants and flavorings, organic esters such as methyl acetate or menthyl acetate and terpenes such as menthone are mentioned. In particular menthone and methyl acetate are contained in a high percentage proportion in mint oil, for example, and therefore in particular in the case of such substances, an effect which is harmful to health is completely precluded in the event of proper handling. Furthermore, cumarin derivatives are also conceivable here.

The odor-producing group may be in the corresponding molecule or a side group or a molecular part of the corresponding material or the corresponding chemical substance. Fundamentally, the detection substance may be in particular a non-toxic compound with a strong smell, in particular an organic sulfur compound, an organic sulfur-phosphorus compound, an organic sulfur-nitrogen compound, an organic phosphorus-nitrogen compound, or an organic nitrogen compound, in particular an amine, or an acrylate.

An organic compound may be, within the meaning of the present invention, in particular a compound which may contain carbon or also carbon and hydrogen.

Within the scope of another embodiment, the detection substance may be detectable by its color. In this embodiment, the detection substance may therefore have in particular a synthetic or natural color and or a substance used as a colorant, which may be added to the mostly colorless electrolyte. A colorant may be provided alternatively or additionally to an odorant, for example, whereby a leak, for example, in the form of a micro-crack, may be indicated immediately not only in an olfactory way, but rather additionally or alternatively also visually.

For this purpose, in particular neutral, nonpolar, and inert materials are preferably suitable, for example, polycyclic aromatic hydrocarbons (PAH) and their functionalized derivatives, for example, diphenyl anthracene, stilbene, cumarin, perylene, triphenyl methane colorants and their derivatives, which may have fluorescent properties, for example.

The present invention fundamentally includes (fluorescent) colorants, inter alia, berberine, chinin, fluorescein, phenoxazine and porphyrin derivatives, ionic colorants based on rhodamine or indocyanine, and classes containing nitrogen, oxygen, and/or sulfur heterocyclic compounds.

In particular in the case of fluorescent colorants, the external skin of the finished cell or the housing may be irradiated using the absorption wavelength of the colorant. A potential leak will then be immediately visible due to the strong fluorescence of the colorant or the colored electrolyte, for example.

In principle, the use of colorants based on nitro, nitroso, indigoid, phenothiazine, azo, anthraquinone, alizarin, indanthrene, pthalocyanine, anthocyanin, sulfonyl, sulfate, or dioxazine, and containing nitrogen, oxygen, and/or sulfur heterocyclic compounds and ionic colorants is also conceivable. Colorants which are based on the heterocyclic compounds related thereto and functional derivatives of the above-mentioned materials are explicitly included. Possible side groups will be listed hereafter.

Also, in one embodiment, all other organic and inorganic materials or phosphors, preferably in nanoscale form, which are colored or are capable of fluorescence, luminescence, and/or phosphorescence, may be used.

As for the above-mentioned odorants, it is also true for the added colorants that they may bear functional groups, inter alia, carbon-carbon double or triple bonds, nitrile, amine, sulfonate, sulfite, sulfide, sultone, sultone, hydroxy, thiol, formyl, carbamate, ester, acid anhydride, or carbonate groups, depending on the redox potentials, participation in the SEI formation processes on the anode and/or the protective layer formation on the cathode being assumed. It is therefore conceivable to adapt the side groups/functionalities of the colorants to the system or select them so that the formation of the SEI is also positively influenced here.

Furthermore, colorants which are capable of chemoluminescence may also be used, which react either with an agent situated in the electrolyte or in the air or with the air itself or a component applied later to the external envelope of the cell.

If the detection substance, for example, the odorants or the colorants or the derivatives thereof, for example, contains functional groups, inter alia, carbon-carbon double or triple bonds, nitrile, amine, sulfonate, sulfide, sulfide, sulfone, sultone, hydroxy, thiol, formyl, carbamate, ester, acid anhydride, or carbonate groups, or mixtures of the above-mentioned groups, depending on the redox potentials, participation in the SEI formation processes on the anode and/or the protective layer formation on the cathode is possible. As described above, this may be used to assist and improve the protective layer formation.

Within the scope of another embodiment, the detection substance may be detectable by a sensor. Thus, in particular, independently of the presence of a user or a person, an escape of the detection substance may be ascertainable by the sensor. In this embodiment, also in the case of partially or completely automated processes or in the case of independently operating devices, which do not require a user for operation, an escape of the detection agent and therefore damage to the energy store may thus be safely and reliably indicated. All sensors which may reliably and effectively detect the detection agent are used as sensors in this embodiment.

For example, the detection substance may change its pH value due to the effect of water or the effect of moisture. Thus, for example, the detection substance, when it exits from the energy store and therefore comes into contact with moist air or with ambient humidity, may be detectable by a change of the pH value and therefore using a pH value measuring device as a sensor. For example, classic indicator substances such as thymol blue, methyl orange, bromcresol green, methyl red, litmus, bromothymol blue, phenolphthalein, thymolphthalein, alizarin yellow, indigo, and related and functionalized derivatives thereof are suitable here.

Alternatively, for example, a mass-spectroscopy device may be used as a sensor, which may scan the immediate surroundings of the energy store. In this embodiment, detection substances may therefore be advantageous in particular which may be detected reliably and precisely in a simple way by mass spectroscopy. For example, substances having a high molecular weight may be used, since these may be detectable simply and reliably on the basis of their mass. Fluorine compounds, which may also include sulfur as an odor-producing substance or also a colorant, for example, are used as an example of such substances. Alternatively or additionally, for example, noble gases may be used, since these are chemically inert as a gas and may be detectable precisely and reliably by mass spectroscopy.

Additionally or alternatively, a pressure sensor may be provided, in particular for the case in which the detection substance represents a gaseous component. In this case, the detection substance may be provided under a predefined pressure in the interior of a housing enclosing the energy store. In the event of escape of the gas, a pressure change in the interior of the housing may permit an inference to a leak or an undesired opening of the housing.

However, this embodiment is not restricted to mass spectroscopy sensors, pressure sensors, or pH meters, for example, but rather any type of a sensor, using which the corresponding detection substance or a property thereof, for example, the pressure, may be detectable safely, precisely, and reliably inside or outside the energy store, may be used.

Within the scope of another embodiment, the detection substance may be present at least partially associated with the electrolyte. In this embodiment, the energy store may particularly reliably detect damage, in the case of which liquid electrolyte could escape, for example. This is because in the event of an escape of the detection substance, damage is very likely present, through which electrolyte could also escape due to the spatial proximity. In addition, the energy store may thus be designed to be particularly compact, which may permit a particularly large variety of the energy store of this design. Providing the detection substance at least partially associated with the electrolyte may denote within the meaning of the present invention in particular that at least a part of the detection substance may be present mixed with the electrolyte or dissolved therein, for example. Fundamentally, the detection substance is not present spatially separated from the electrolyte in this embodiment, but rather may be present at least partially, in particular in the same areas of the energy store, areas separated from the electrolyte additionally also being able to be present.

Within the scope of another embodiment, the detection substance may be present at least partially separated from the electrolyte, in particular spatially separated. According to the present invention, this may be caused by separate storage and/or low miscibility of the substance with the electrolyte, for example. For example, the detection substance may be present completely spatially separated from the electrolyte. In this embodiment, the detection substance may be selected particularly freely, since in particular in the case of a complete spatial separation of detection substance and electrolyte, interaction of these two components may be prevented, whereby chemical inertness or sluggish reactivity of electrolyte and detection substance does not have to be observed. In addition, it may be ensured that in the event of a slight opening of the housing, the detection substance escapes from the energy store and is not retained by the electrolyte due to intermolecular interaction or the like, for example. The detection substance may also be present partially associated with the electrolyte in this embodiment, however.

Reference is hereby explicitly made to the explanations in conjunction with the energy store system according to the present invention with respect to further features and advantages of the energy store according to the present invention.

Furthermore, the object of the present invention is an energy store system, including at least one energy store designed as described above and at least one sensor for detecting the detection substance.

Such an energy store system may operate in a particularly stable and long-lived way, since damage to the energy store, in particular a housing enclosing the energy store, is detectable reliably and safely. In this way, the smallest damage, which is accompanied with an opening of the housing, may already be detected, whereby greater damage, in particular consequential damage, of the energy store, or damage to a component equipped with the energy store, may be avoided.

The energy store may be, for example, but is not restricted to, a lithium-ion battery, which may be usable in manifold applications. The sensor for detecting the detection substance may be, for example, a mass spectroscopy device, a pH meter, or a pressure sensor, without being restricted to the above-mentioned examples. Furthermore, the sensor may be situated inside or outside the energy store or the housing enclosing the energy store. An escape of the detection substance induced by a leak or damage to or a change of specific properties of the detection substance induced by a leak or damage, for example, may thus be detectable inside and/or outside the energy store.

Within the scope of one embodiment, a control unit may be provided, with the aid of which the energy store may be shut down in response to the detection of a leak. In this embodiment, therefore, not only may a leak of the energy store be reliably detected, but rather appropriate countermeasures may be taken in response to the detection of the leak, in particular to prevent more extensive damage.

Reference is hereby explicitly made to the explanations in conjunction with the energy store according to the present invention with respect to further features and advantages of the energy store system according to the present invention.

What is claimed is:

1. An electrochemical energy store, comprising:
a cell chamber having at least one anode, at least one cathode, and an electrolyte, wherein the electrolyte is situated between the anode and the cathode; and
a housing separating the cell chamber from the external surroundings, wherein at least one detection substance for detection of a leak of the housing is situated in the cell chamber.

2. The energy store as recited in claim 1, wherein the detection substance includes one of a gas or a low-boiling liquid.

3. The energy store as recited in claim 2, wherein the detection substance includes at least one of: nitrogenous substances; sulfurous substances; phosphoric substances; hydrogenous substances; carbonaceous substances; substances containing oxygen; hydrocarbon compounds; hydrocarbon acids; hydrocarbon salts; and heterocyclic compounds.

4. The energy store as recited in claim 3, wherein the detection substance is detectable by odor of the detection substance.

5. The energy store as recited in claim 4, wherein the detection substance includes at least one of: aromatic substances, esters, ethers, terpenes, alkyl pyrazines, ketones, aldehydes, lactones, acrylates, amines, nitriles, alcohols, mercaptans, thiols, thioethers, phosphides, and phosphones.

6. The energy store as recited in claim 3, wherein the detection substance is detectable by color of the detection substance.

7. The energy store as recited in claim 6, wherein the detection substance includes at least one of: diphenyl anthracene; stilbene; cumarin; perylene; triphenyl methane colorants; berberine; chinin; fluorescein; phenoxazine; porphyrin; ionic colorants based on rhodamine; ionic colorants based on indocyanine; nitrogen heterocyclic compounds; oxygen heterocyclic compounds; sulfur heterocyclic compounds; and colorants based on one of nitro, nitroso, indigoid, phenothiazine, azo, anthraquinone, alizarin, indanthrene, pthalocyanine, anthocyanin, sulfonyl, sulfate, or dioxazine.

8. The energy store as recited in claim 6, wherein the detection substance includes at least one of an ionic colorant, a fluorescent colorant, a luminescent colorant, a phosphorescent colorant, and a chemoluminescent colorant.

9. The energy store as recited in claim 3, wherein the detection substance includes at least one of the following functional groups: carbon-carbon double bonds, caron-carbon triple bonds, nitrile, amine, sulfonate, sulfite, sulfide, sultone, sultone, hydroxy, thiol, formyl, carbamate, acid anhydride, ester, and carbonate groups.

10. The energy store as recited in claim 3, wherein the detection substance is detectable by a sensor.

11. The energy store as recited in claim 3, wherein the detection substance is present at least partially associated with the electrolyte.

12. The energy store as recited in claim 3, wherein the detection substance is present at least partially separated from the electrolyte.

13. An energy store system, comprising:
an electrochemical energy store including:
a cell chamber having at least one anode, at least one cathode, and an electrolyte, wherein the electrolyte is situated between the anode and the cathode; and
a housing separating the cell chamber from the external surroundings, wherein at least one detection substance for detection of a leak of the housing is situated in the cell chamber, wherein the detection substance includes at least one of: nitrogenous substances; sulfurous substances; phosphoric substances; hydrogenous substances; carbonaceous substances; substances containing oxygen; hydrocarbon compounds; hydrocarbon acids; hydrocarbon salts; and heterocyclic compounds; and
at least one detector for the detection of the detection substance.

14. The energy store system as recited in claim 13, further comprising:
a control unit configured to shut down the energy store in response to the detection of a leak.
